(19) United States
(12) Patent Application Publication
(10) Pub. No.: US 2025/0168084 A1
(43) Pub. Date: May 22, 2025

(54) Edge Device for a Distributed Traffic Engineering System With Quality of Service Control of a Plurality of Flow Groups

(71) Applicant: Huawei Technologies Co., Ltd., Shenzhen (CN)

(72) Inventors: Tran Anh Quang Pham, Boulogne Billancourt (FR); Youcef Magnouche, Boulogne Billancourt (FR); Jeremie Leguay, Boulogne Billancourt (FR); Xu Gong, Moscow (RU)

(21) Appl. No.: 19/027,242

(22) Filed: Jan. 17, 2025

Related U.S. Application Data
(63) Continuation of application No. PCT/CN2022/108355, filed on Jul. 27, 2022.

(51) Int. Cl. H04L 41/5025; H04L 41/5009; H04L 47/2425

(52) U.S. Cl. CPC H04L 41/5025; H04L 41/5009; H04L 47/2425

(57) ABSTRACT

An edge device is for a distributed traffic engineering system with quality of service control of a plurality of flow groups routed over a set of overlay links. The edge device is configured to receive one or more service-level agreement requirements for the plurality of flow groups from a network controller, receive first control information from one or more other edge devices in the distributed traffic engineering system, obtain monitoring information for the plurality of flow groups and the set of overlay links, and adjust a plurality of queuing parameters for the plurality of flow groups based on at least one of the first control information, the monitoring information, or the one or more SLA requirements.

### CROSS-REFERENCE TO RELATED APPLICATIONS

This is a continuation of International Patent Application No. PCT/CN2022/108355 filed on Jul. 27, 2022. The disclosure of the aforementioned application is hereby incorporated by reference in its entirety.

### TECHNICAL FIELD

The present disclosure relates to quality of service control of a plurality of flow groups. The present disclosure proposes an edge device and a corresponding method for operating the edge device.

### BACKGROUND

Traffic engineering is key to control how bandwidth is shared in networks, in particular to satisfy service-level agreements (SLAs) of applications in terms of throughput, delay, loss and jitter. Routing over multiple paths helps to make a better use of a network capacity and allows to dynamically select paths based on network conditions. Flows traversing common links can experience bandwidth competition, therefore degrading quality of service (QoS). QoS policies may help to control bandwidth sharing between concurrent flows.

Multi-path routing along with QoS policies are used in software-defined wide area networks (SD-WAN) where a headquarter site and local branches of an enterprise can be interconnected through different networks, e.g., Multi-Label Protocol Switching (MLPS), Internet, and/or Long-Term Evolution (LTE). In such overlay networks, a controller entity is deployed at the headquarter site to manage the network while premises are equipped with access routers (ARs). The controller is responsible for the configuration of access routers and the update of high-level routing policies. In turn, access routers route traffic over the set of available overlay links so as to align with the policy defined by the controller and the local knowledge of network conditions (e.g. average delay, loss, jitter of overlay links).

Applications are generally mapped to different “flow groups” with different QoS requirements, for instance: Production (Moderate traffic, High SLA requirements), Voice over Internet Protocol (VoIP) (Moderate Traffic, High SLA requirements), Office (High traffic, Moderate SLA requirements), and Data (Moderate traffic, Low/No SLA requirements).

To satisfy flow groups requirements, a class-based queuing (CBQ) architecture is used for traffic scheduling. Each access router applies a QoS policy at each of its outgoing ports before traffic enters into the wide area network (WAN) area. A strict priority (SP) scheduler is used to give priority to high-priority flow groups (e.g., Real-time traffic like VoIP or production traffic) and a Weighted-Fair Queuing (WFQ) scheduler along with shapers is used to control how much bandwidth is allocated to low-priority flow groups.

The shaping rates and the WFQ weights for each flow group at egress ports of access routers may be determined. For example, one method is to assign fixed values based on relative priorities of flow groups. However, performance can be improved with a dynamic adaptation of parameters. When the network is not congested, the adaptation of weights can be used to provide more bandwidth or “service rate” to a flow group in order to reduce its latency. The latency can be further improved when the end-to-end latency requirement is already met or stricter latency requirements could be addressed. When the network is congested, shaping can be tuned to protect high priority flow groups, e.g., leaving them enough service rate so that they can meet their latency requirements, and to ensure fairness between low priority flow groups, e.g., proportionally reduce the bandwidth of all of them.

The adaptation of QoS parameters, e.g., shaping and weights, requires to solve a global optimization problem and cannot be done by each access router in an isolated manner. When several access routers send traffic over a same bottleneck link, the overall SLA satisfaction may not be maximized and the fairness in case of congestion may not be ensured. For example, an enterprise branch may be connected to two data centers via a MPLS virtual private network (VPN) and Broadband Internet. When the two datacenters are sending traffic from a first port and a second port for MPLS to a third port of the Branch, they both compete on the same bottleneck. Once path selection has been realized to choose between MPLS and Internet for a set of flow groups, the QoS policies applied at the first and second port can help to protect high-priority traffic and better share bandwidth within low-priority flow groups to meet SLA requirements and ensure fairness in case of congestion.

As traffic and network conditions evolve over time, QoS policies and routing may be adjusted to better use network resources and meet application requirements.

A number of active queue management (AQM), traffic conditioning, and network scheduling techniques have been proposed to help sustain delay and throughput requirements. In general, AQM is about implicit, for example through packet dropping, or explicit, for example explicit congestion notification (ECN) marking or bandwidth pricing, signals to control several sources or destinations sharing bottleneck links to tune queuing parameters and optimize performance globally.

Further, a dynamic adaptation of scheduling parameters may be used, for instance, with adaptive weighted fair queuing (AWFQ) comprising: The control of output queues for an access device. A centralized approach with a bandwidth broker. A distributed protocol to trigger queue adjustments. The agents at the destination inform about delay violations such that upstream agents adjust their weights.

An “Adaptive QoS” solution may enable WAN interface shapers and per-tunnel shapers at the enterprise edge to adapt to the available WAN bandwidth. Local UP/DOWN decisions to increase or decrease shaping parameters may be taken based on packet losses. However, this approach may only reach a local optimum.

The performance routing (PfR)/intelligent WAN (iWAN) solution has been proposed for the dynamic selection of paths in WAN networks to satisfy SLA requirements. In this architecture, the user defines a policy at a Master Controller (MC) level in terms of SLA requirements for each application. Access routers monitor the quality of the paths and send monitoring updates to the MC. The MC then compares the quality of paths with application requirements and updates the path selection in routers if needed. This approach requires frequent communication between the device and the controller as paths are actually selected in the MC. Thus, the MC is slow to react to the change of network conditions. Furthermore, this only controls routing and does not optimize the QoS policy inside devices.

### SUMMARY

In view of the above, embodiments of this disclosure aim to provide efficient queuing parameter optimization inside edge devices.

These and other objectives are achieved by the embodiments of this disclosure as described in the enclosed independent claims. Advantageous implementations of the embodiments are further defined in the dependent claims.

A first aspect of this disclosure provides an edge device for a distributed traffic engineering system with QoS, control of a plurality of flow groups routed over a set of overlay links, wherein the edge device, for example a QoS agent and/or a scheduling optimization module comprised in the edge device, is configured to: receive one or more SLA requirements for the plurality of flow groups from a network controller, receive a first control information from one or more other edge devices in the distributed traffic engineering system, obtain a monitoring information for the plurality of flow groups and the set of overlay links, and adjust a plurality of queuing parameters for the plurality of flow groups based on at least one of the first control information, the monitoring information, and the one or more SLA requirements.

For example, the edge device may be configured to adjust the plurality of queuing parameters for the plurality of flow groups based on the first control information, the monitoring information, and the one or more SLA requirements.

If an edge device determines that some SLA cannot be satisfied, the edge device may send a help request.

A global framework may be defined to optimize queuing parameters through cooperation among edge devices.

The edge device may determine queuing parameters based on global rate-based decision-making based on SLA measurements and predictions.

In a further implementation form of the first aspect, the edge device comprises a control plane, wherein the control plane comprises a QoS agent, for example, the QoS agent of the first aspect, and/or a routing agent; and/or wherein the QoS agent comprises a scheduling optimization module, for example, the scheduling optimization module of the first aspect, and/or an analysis module to support generation of help requests; and/or wherein the edge device comprises a data plane, and wherein the data plane comprises a scheduling engine, a monitoring engine, and/or a forwarding engine.

In a further implementation form of the first aspect, the edge device, for example the QoS agent, is further configured to: determine if a help request is required based on the monitoring information and the one or more SLA requirements, and provide, if a help request is required, a help request to the network controller.

In a further implementation form of the first aspect, the edge device, for example the routing agent, is further configured to receive, if a help request is provided to the network controller by at least one edge device in the distributed traffic engineering system, a routing policy from the network controller.

The routing policy may be a Smart Policy Routing (SPR) policy.

In a further implementation form of the first aspect, the edge device, for example the QoS agent, is further configured to: determine a second control information based on the plurality of adjusted queuing parameters and/or the monitoring information, and provide the second control information to the one or more other edge devices.

The edge device and the one or more other edge devices may be configured to communicate control information between each other. Being configured to communicate control information may comprise being configured to respectively receive a first control information and/or provide a second control information one or more times.

The edge device may be configured to respectively receive a first control information and/or provide a second control information more often and/or with a higher frequency of repetition than the other steps that the edge device is configured to perform.

In a further implementation form of the first aspect, the edge device, for example the QoS agent, is further configured to receive, from the network controller, one or more end points for the help request.

In a further implementation form of the first aspect, the edge device, for example the QoS agent and/or the scheduling optimization module, is further configured to adjust the plurality of queuing parameters further based on an SLA prediction model.

In a further implementation form of the first aspect, the edge device, for example the QoS agent and/or the scheduling optimization module, is further configured to periodically and/or repeatedly: receive a first control information from one or more other edge devices in the distributed traffic engineering system, obtain a monitoring information of the plurality of flow groups, adjust iteratively the plurality of queuing parameters for the plurality of flow groups based on the first control information and/or the monitoring information, determine a second control information based on the plurality of adjusted queuing parameters, and provide the second control information to the one or more other edge devices.

In a further implementation form of the first aspect, the edge device is further configured to periodically and/or repeatedly: determine if a help request is required based on the monitoring information and the one or more SLA requirements, and provide, if a help request is required, a help request to the network controller, and/or receive, if a help request is provided to the network controller by at least one edge device in the distributed traffic engineering system, the routing policy from the network controller.

For example, the routing agent may be configured to receive the routing policy from the network controller and the QoS agent and/or the analysis module may be configured to determine if a help request is required and provide the help request to the network controller.

In a further implementation form of the first aspect, the second control information comprises a load for each overlay link in the set of overlay links and/or one scalar for each flow group of the plurality of flow groups, and/or wherein the first control information comprises a load for each overlay link in a second set of overlay links corresponding to the one or more other edge devices and/or one scalar for each flow group of a second plurality of flow groups corresponding to the one or more other edge devices.

In a further implementation form of the first aspect, the plurality of queuing parameters comprises shaping rates for each flow group and/or WFQ weights for each flow group, and/or wherein the one or more SLA requirements comprise at least one of a throughput, a latency, and jitter and loss requirements for each flow group of the plurality of flow groups.

In a further implementation form of the first aspect, the scheduling optimization module is configured to provide the plurality of adjusted queuing parameters to the scheduling engine, and/or wherein the scheduling engine is configured to enforce a bandwidth sharing policy to guarantee the SLA requirements and/or fairness according to a fairness objective.

In a further implementation form of the first aspect, the QoS agent, for example the analysis module, is configured to obtain the monitoring information from the monitoring engine, and/or wherein the monitoring engine is configured to determine the monitoring information based on measurements of each flow group of the plurality of flow groups.

In a further implementation form of the first aspect, the routing agent is configured to receive, if a help request is provided to the network controller by at least one edge device in the distributed traffic engineering system, the routing policy from the network controller, and/or the help request from the QoS agent, for example the analysis module, and provide the routing policy to the forwarding engine.

If the help request is provided to the network controller by the edge device, the forwarding engine may anticipate receiving the routing policy from the routing agent.

In a further implementation form of the first aspect, the edge device, for example the forwarding engine, is configured to forward traffic of each flow group of the plurality of flow groups over the set of overlay links, for example based on the routing policy.

In a further implementation form of the first aspect, the analysis module is configured to: receive the monitoring information from the monitoring engine, and/or receive the plurality of adjusted queuing parameters from the scheduling optimization module, determine if a help request is required based on the monitoring information and the one or more SLA requirements and/or the plurality of adjusted queuing parameters, and provide, if a help request is required, the help request to the network controller and/or the routing agent.

In a further implementation form of the first aspect, the edge device, for example the analysis module, is further configured to determine if a help request is required further based on an SLA prediction model, and/or based on determining and/or predicting if the one or more SLA requirements are met.

In a further implementation form of the first aspect, the edge device, for example the scheduling optimization module, is configured to determine a plurality of rate allocations comprising a rate allocation over each overlay link of the set of overlay links for every flow group of the plurality of flow groups, and adjust the plurality of queuing parameters based on the plurality of rate allocations, and/or wherein determining the plurality of rate allocations is based on: the first control information, the monitoring information, the one or more SLA requirements, and optionally the SLA prediction model.

In a further implementation form of the first aspect, the monitoring information comprises for each flow group of the plurality of flow groups and/or for each overlay link in the set of overlay links a measured throughput, and/or QoS statistics, wherein the QoS statistics comprise at least one of a latency, a jitter, and a loss.

In a further implementation form of the first aspect, the edge device, for example the analysis module, is configured to: compare the measured throughput of each flow group of the plurality of flow groups with the one or more SLA requirements and/or with the plurality of rate allocations, and provide, if the measured throughput is not high enough to satisfy at least one of the one or more SLA requirements, the help request to at least one of the routing agent, the network controller, and the one or more end points for the help request.

In a further implementation form of the first aspect, the edge device, for example the scheduling optimization module, is configured to use a CBQ architecture for adjusting the plurality of queuing parameters.

The CBQ architecture may be based on a QoS optimization model and/or may comprise meeting SLA requirements for every flow group of the plurality of flow groups, protecting high-priority flow groups by, for example, guaranteeing that SLA requirements are met, and ensuring fairness for low priority flow groups according to a fairness constraint by, for example, eliminating omission of each low priority flow groups.

The CBQ architecture may be based on a QoS optimization model and/or may comprise meeting SLA requirements for all flow groups corresponding to the edge device and the one or more other edge devices in the distributed traffic engineering system, protecting high-priority flow groups by, for example, guaranteeing that SLA requirements are met, and ensuring fairness for low priority flow groups according to a fairness constraint by, for example, eliminating omission of each low priority flow groups.

In a further implementation form of the first aspect, the edge device, for example the scheduling optimization module, is configured to determine the plurality of rate allocations based on a QoS optimization model.

The QoS optimization model may minimize SLA violations and/or rate violations according to an objective function.

In a further implementation form of the first aspect, the QoS optimization model includes at least one of the following constraints: the capacities of each overlay link of the set of overlay links is satisfied, an objective for fairness of rate allocations, and/or wherein the edge device, for example the scheduling optimization module, is configured to determine SLA violations, rate allocations and/or rate violations, and wherein the QoS optimization model is based on the SLA violations, the rate allocations and/or the rate violations.

In a further implementation form of the first aspect, the constraint that the capacities of each overlay link of the set of overlay links is satisfied is relaxed according to a Lagrangian relaxation model, and wherein the edge device, for example the scheduling optimization module, is configured to penalize violations of the relaxed constraint using Lagrange multipliers λ ∈ R⁺, which impose a cost on constraint violations.

In a further implementation form of the first aspect, the QoS optimization model includes at least one of the following inputs: one or more flow groups, one or more tunnels, wherein each tunnel is defined by an origin and the destination, the plurality of flow groups, and/or wherein each flow group is defined by a class of traffic and its origin and destination, a traffic demand of each flow group on each overlay link, the SLA prediction model for each flow group on each overlay link, an SLA requirement of each flow group, a penalty of demand violation of each flow group; and/or wherein the QoS optimization model includes at least one of the following outputs: a rate allocation of each flow group on each overlay link, an SLA violation of each flow group on each overlay link, a rate violation of each flow group on each overlay link, an intermediate variable of each flow group on each overlay link to optimize fairness according to a fairness objective.

In a further implementation form of the first aspect, the fairness objective is based on at least one of a minimum and/or maximum rate allocation for each flow group of the plurality of flow groups, and a proportional rate allocation constraint for each flow group of the plurality of flow groups.

A second aspect of this disclosure provides a network controller for a distributed traffic engineering system with Quality of Service, QoS, control of a plurality of flow groups routed over a set of overlay links, wherein the network controller is configured to: provide SLA requirements for each flow group of the plurality of flow groups to two or more edge devices of the distributed traffic engineering system, receive a help request from at least one edge device of the two or more edge devices, and provide a routing policy to at least one edge device of the two or more edge device.

The network controller may determine the routing policy based on information regarding all flow groups and set of overlay links corresponding to the two or more edge devices, wherein the information may be obtained from the two or more edge devices.

In a further implementation form of the second aspect, the network controller is further configured to provide one or more end points for a help request to the two or more edge devices.

A third aspect of this disclosure provides a method of operating an edge device for a distributed traffic engineering system with Quality of Service, QoS, control of the plurality of flow groups routed over a set of overlay links, wherein the method comprises: receiving one or more Service Level Agreement, SLA, requirements for the plurality of flow groups from a network controller, receiving a first control information from one or more other edge devices in the distributed traffic engineering system, obtaining a monitoring information for the plurality of flow groups and the set of overlay links, and adjusting a plurality of queuing parameters for the plurality of flow groups based on at least one of the first control information, the monitoring information, and the one or more SLA requirements.

The method of the third aspect may have implementation forms that correspond to the implementation forms of the device of the first aspect. The method of the second aspect and its implementation forms achieve the advantages and effects described above for the device of the first aspect and its respective implementation forms.

In this disclosure the “edge devices” may also be referred to as “Access Routers” or “switches”.

Further, in this disclosure the analysis module may be referred to as “Rate & SLA Analysis module”.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows an edge device according to an embodiment of this disclosure.

FIG. 2 shows a network controller according to an embodiment of this disclosure.

FIG. 3 shows an exemplary architecture of an edge device and a network controller.

FIG. 4 shows an exemplary architecture of an edge device and a network controller.

FIG. 5 shows an exemplary procedure performed by an edge device for adjusting queuing parameters according to an embodiment of this disclosure.

FIG. 6 shows steps that may be performed by an edge device to trigger a help request according to an embodiment of this disclosure.

FIG. 7 shows a method according to an embodiment of this disclosure.

### DESCRIPTION OF EMBODIMENTS

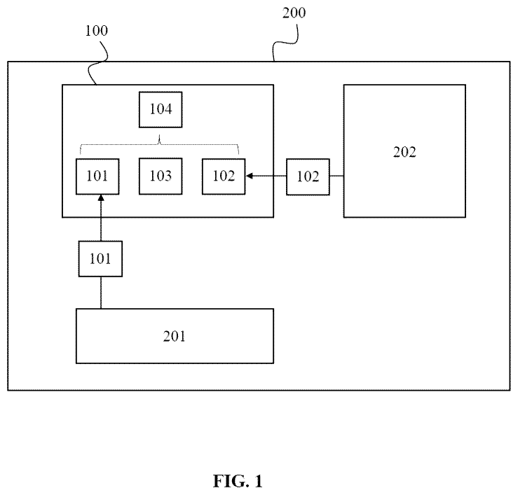

FIG. 1 shows an edge device 100 according to an embodiment of this disclosure. Further, FIG. 1 shows a distributed traffic engineering system 200, comprising the edge device 100, a network controller 201, and one or more other edge devices 202, wherein the edge device 100 and/or the distributed traffic engineering system has QoS control of a plurality of flow groups routed over a set of overlay links. The edge device 100 is configured to receive one or more SLA requirements for the plurality of flow groups from the network controller 201, and receive a first control information 102 from the one or more other edge devices 202 in the distributed traffic engineering system 200. Further, the edge device 100 is configured to obtain a monitoring information 103 for the plurality of flow groups and the set of overlay links, and adjust a plurality of queuing parameters 104 for the plurality of flow groups based on at least one of the first control information 102, the monitoring information 103, and the one or more SLA requirements 101.

In this disclosure, an edge device 100 corresponding to a plurality of flow groups routed over a set of overlay links may refer to the plurality of flow groups routed over the set of overlay links being managed by the edge device 100.

The plurality of flow groups routed over the set of overlay links may correspond only to the edge device 100. Alternatively, the plurality of flow groups routed over the set of overlay links may correspond to the edge device 100 and the one or more other edge devices 202.

The distributed traffic engineering system 200 may manage one or more pluralities of flow groups routed over one or more sets of overlay links. Each edge device 100 in the distributed traffic engineering system 200 may manage a different plurality of flow groups of the one or more pluralities of flow groups routed over a different set of overlay links of the one or more sets of overlay links.

The communication between the network controller 201 and the edge device 100 may be minimized, and/or the communication between the edge device 100 and the other edge devices may be minimized.

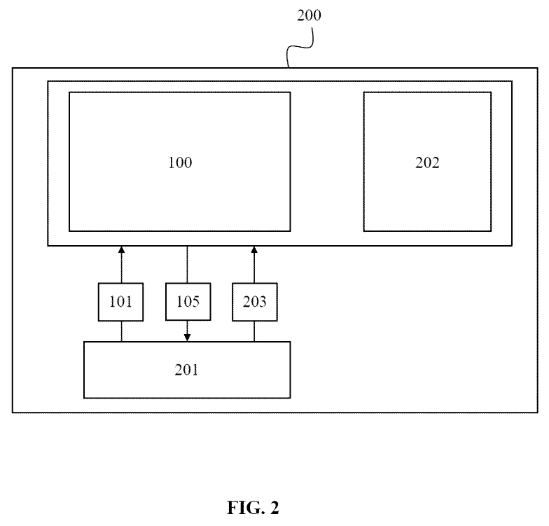

FIG. 2 shows a network controller 201 according to an embodiment of this disclosure. Further, FIG. 2 shows a distributed traffic engineering system 200, comprising the network controller 201, an edge device 100, and one or more other edge devices 202 forming two or more edge devices 100, 202, wherein the distributed traffic engineering system 200 has QoS control of a plurality of flow groups routed over a set of overlay links. The network controller 201 is configured to provide SLA requirements 101 for each flow group of the plurality of flow groups to the two or more edge devices 100, 202 of the distributed traffic engineering system 200, receive a help request 105 from at least one edge device 100 of the two or more edge devices 100, 202, and provide a routing policy 203 to at least one edge device 100 of the two or more edge devices 100, 202.

The network controller 201 may provide the routing policy 203 to a different edge device 100 than the edge device 100 from which the help request 105 is received. Alternatively, the network controller 201 may provide the routing policy 203 to a same edge device 100 from which the help request 105 is received.

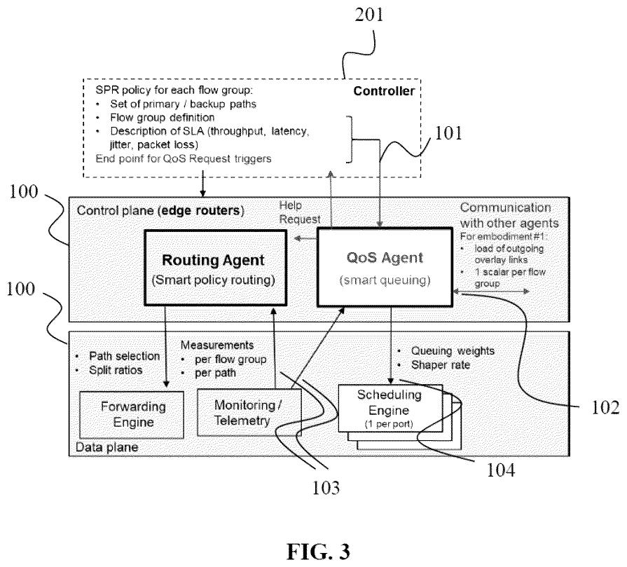

Each edge device 100 in the distributed traffic engendering system 200 may comprise an intent-based “QoS Agent” module. FIG. 3 shows an exemplary architecture of an edge device 100 and a network controller 201, and how the edge device 100 may interact with the network controller 201 and the one or more other edge devices 202.

FIG. 3 shows the exemplary edge device 100 equipped with a control plane and a data plane. In the data plane, a monitoring module provides for each flow group and per overlay link the throughput information and QoS statistics 103, e.g., delay, jitter, and loss rate. A forwarding engine module forwards the traffic of each flow group over the set of overlay links. The routing policy 203 is given by a local routing agent. For instance, the routing agent may decide to load balance traffic over a set of selected active links with weights that are inversely proportional to the capacity of the physical ports, for example when implemented based on a SPR policy. The set of active/backup overlay links and/or paths is determined by a centralized controller, for example the network controller 201, based on SLA requirements 101 and measurements 103.

A QoS agent may continuously adjust the plurality of queuing parameters 104, e.g., WFQ weights and/or shaping rates, based on the SLA requirements 101, local measurements 103, and control information 102 received from other QoS agents of other edge devices. Two objectives of the QoS agent may be: 1) Meet SLA requirements 101 of the plurality of flow groups, and 2) efficiently and/or fairly handle congestion. In addition, when the QoS agent detects SLA violations, it can send a “help request” signal 105 to an external system, for instance the routing system running at the network controller 201 and/or a local routing agent, to ask for help, e.g., update a SPR policy and/or turn on forward error correction (FEC). The QoS agent may provide a plurality of adjusted queuing parameters 104, e.g., WFQ weights and/or shaping rates, to the scheduling engine which may enforce a bandwidth sharing policy to guarantee the SLA requirements 101 and fairness, for example according to a fairness objective. A minimum and maximum rate allocation can be configured for each flow group thanks to traffic scheduling, e.g. WFQ and traffic shaping.

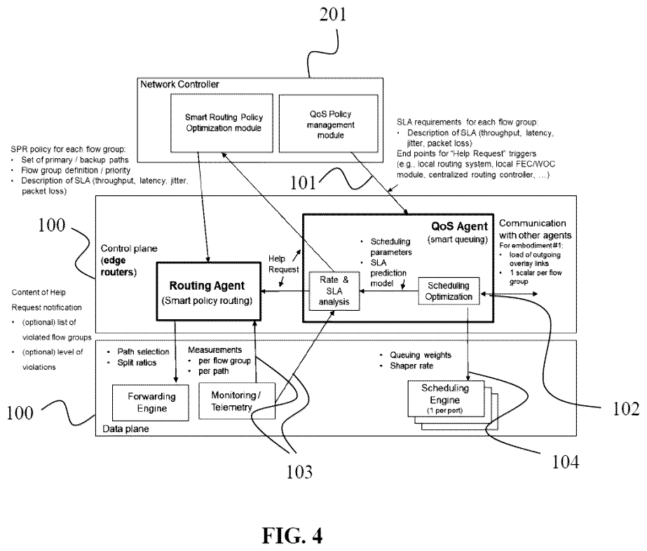

FIG. 4 shows a more detailed exemplary architecture of an edge device 100 and a network controller 201. The QoS Agent is split into two modules: 1) the scheduling optimization module which optimize in a distributed manner jointly with other QoS Agents the plurality of queuing parameters 104, and 2) the Rate & SLA Analysis module which verifies if SLAs are met and asks for help if needed.

The QoS Agent module can receive the following input data from the network controller 201: The SLA requirements 101, e.g., in terms of throughput, jitter, delay, loss for each flow group. A list of endpoints to address “help request 105” messages when needed, e.g., local routing system, local FEC/WAN optimization controller (WOC) module, centralized routing controller.

Based on SLA requirements 101 and measurements 103 for the flow groups, e.g. the flow groups for which the egress port is the local access router 100, the edge device 100 manages the scheduling optimization module of the edge device 100 to continuously adjust the plurality queuing parameters 104, e.g. shaping rates, WFQ weights. In order to coordinate with other QoS agents, the scheduling optimization module applies a distributed optimization method that requires for instance the exchange at each iteration of the algorithm of 1) load of outgoing overlay links and 2) one scalar per flow group. This method can embed or not an SLA prediction model to anticipate the impact of the plurality of adjusted queuing parameters 104 on SLAs of flow groups.

Each update and/or adjustment of queueing parameters 104 may be provided to the Rate & SLA Analysis module jointly with the indication of the SLA prediction model that may be used by the scheduling optimization module. Based on this information and local measurements 103 from telemetry on end-to-end QoS parameters, the Rate & SLA Analysis module may continuously verify if SLAs of the respective flow groups are met. If the Rate & SLA Analysis module may determine that the scheduling optimization module cannot improve SLA satisfaction, the Rate & SLA Analysis module may decide to trigger a help request 105. Such a notification contains for instance 1) a list of violated flow groups and 2) the level of violations. The Rate & SLA Analysis may target with the help request 105 the routing system locally or directly at the network controller 201 such that load balancing is adjusted.

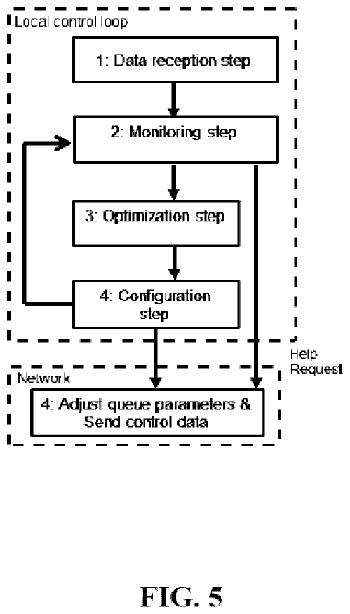

FIG. 5 shows an exemplary procedure performed by an edge device 100 for adjusting the plurality of queuing parameters 104. The steps of an exemplary procedure may comprise:

Step 1: Edge device 100 receives updated information in a data reception step:

SLA requirements 101 from the network controller 201: Description of SLA (throughput, latency, jitter, packet loss) for each flow group, and End-points for help requests 105.

Control information 102 from other edge QoS agents.

Information from monitoring 103 for each flow group.

Step 2: Monitoring step:

Compare measured/predicted SLAs 103 with SLA requirements 101.

If an SLA violation is detected, send a notification using help request 105 end-points.

Step 3: Optimization step:

Solve the QoS optimization problem to compute new queuing parameters 104 based on, for example, an SLA prediction model.

Prepare control information for other edge QoS agents, for example, load of outgoing overlay links, and one scalar per flow group.

Step 4: Enforce rate allocation and send control data in a configuration step:

Enforce queuing parameters 104 and provide them to the monitoring module.

Send control information 102 to the one or more other QoS agents for coordination.

Repeat the Steps 1 to 4 one or more times in a local control loop.

All values measured and/or received, for example link loads, may be averaged over moving time windows to smooth variations.

An iteration may be executed periodically and/or after a minimum number of updates is received from other QoS agents.

The plurality of queuing parameters 104 may be optimized through cooperation and in a distributed manner among a set of access routers sharing the same resources. Once a target is provided by the network controller 201, QoS agents may operate at a high frequency without involving the network controller 201. However, if the situation cannot be improved and SLAs are still violated, the set of access routers can ask for help.

QoS agents may use SLA predictions based on closed-form data-driven models.

Other scheduling architectures may be supported, e.g., hierarchical token bucket, Weighted Deficit Round Robin.

Exchanges between QoS agents may be on top of existing protocols, e.g., Open Shortest Path First, Border Gateway Protocol.

A system for distributed smart queuing may be based on at least one of Edge devices 100, 202 that determine for each flow group they manage the queuing parameters 104 by exchanging control information 102 with other edge devices; decisions may be taken iteratively to 1) maximize SLA satisfaction and 2) ensure fairness in case of congestion. An SLA prediction model may be used; and help can be requested from the network controller 201 based on SLA measurements.

A method for optimal utility-based and fair allocation may comprise: Edge devices 100, 202 implementing a distributed algorithm that receive small data sizes of control information 102 from other edge devices and may adjust queuing parameters 104 at each iteration.

A method to trigger an adjustment of routing policies may comprise: Adjustments that are based on the monitoring and prediction of SLAs for each flow group.

The following provides an example of the scheduling optimization module when a CBQ architecture is used for the adaption of the plurality of queuing parameters 104. The objective is to protect high-priority flows, meet SLA requirements 101 for all flow groups and ensure fairness for low priority flows.

Fairness may be ensured according to a fairness objective.

The edge device 100 may be configured to determine the plurality of rate allocations based on a QoS optimization model and/or an objective function.

The inputs of the QoS optimization model may be at least one of H classes of traffic; N tunnels, each one is defined by the origin and the destination; K flowgroups=H×N, each flowgroup is defined by a class of traffic and its origin and destination; dₖ^{l}: traffic demand of flowgroup k on overlay link l; fₖ^{l}(X′): SLA prediction model for flowgroup k on overlay link l, X^{l}=[x₀^{l}, . . . , x_{K-1}^{l}]; qₖ: SLA requirement of flowgroup k; and Mₖ: penalty of demand violation of flowgroup k.

The outputs, for example decision variables, may be at least one of xₖ^{l}: rate allocation of flowgroup k on overlay link l. The rate allocation may be larger than or equal to the demand; yₖ^{l}: SLA violation of flowgroup k on overlay link l; hₖ^{l}: rate violation of flowgroup k on overlay link l; and zₖ^{l}: intermediate variable of flowgroup k and overlay link 1, to optimize fairness in the objective function.

xₖ^{l} may be considered to be a main output and may be sent to the scheduling engine to redirect the incoming flows to appropriate overlay links.

The following non-Linear programming model computes the rate allocations over each overlay link for every flow group. It penalizes the SLA violation and the rate violation in the objective function. The QoS optimization model and/or the objective function may be defined as follows:

$$min {\sum }_{l} ( {\sum }_{k} {z}_{k}^{l} + {\sum }_{k : {d}_{k}^{l} ( t ) > 0} ( \frac{{y}_{k}^{l}}{{q}_{{p}_{k}}} + {M}_{k} \times {h}_{k}^{l} ) )$$

Wherein:

$${\sum }_{k} {x}_{k}^{l} \leq {c}_{l} , ∀ l , \qquad ( 1 )$$

$${f}_{k}^{l} ( {X}_{k}^{l} ) \leq {q}_{k} + {y}_{k}^{l} , ∀ k : {d}_{k}^{l} > 0 , l , \qquad ( 2 )$$

$${x}_{k}^{l} + {h}_{k}^{l} \geq {max}_{t} {d}_{k}^{l} ( t ) , ∀ k , l , \qquad ( 3 )$$

$$- {d}_{k}^{l} log {x}_{k}^{l} \leq {z}_{k}^{l} , ∀ l , k , {y}_{k}^{l} \geq 0 , ∀ k , l , \qquad ( 4 )$$

Constraints (1) guarantees that all link capacities are satisfied. Constraints (2) allow to compute the SLA violation. Constraints (3) allow to compute the rate allocation, and when the capacities are not enough, the rate violations are computed. Constraints (4) link variables x and variables z in order to ensure fairness and may be referred to as a fairness objective. The objective function may minimize the rate & the SLA violations.

Constraints (1) may be relaxed to obtain the following Lagrangian relaxation of the problem.

The Lagrangian relaxation method penalizes violations of inequality constraints using a Lagrange multipliers λ ∈ [symbol] ⁺, which imposes a cost on violations. After relaxing capacity constraints (1), the following Lagrangian relaxation problem may be obtained:

$${min}_{λ} - {\sum }_{l} {λ}_{l} {c}_{l} + {min}_{x , z} {\sum }_{l} ( {\sum }_{k} ( {z}_{k}^{l} + {λ}_{l} {x}_{k}^{l} ) + {\sum }_{k : {d}_{k}^{l} ( t ) > 0} ( \frac{{y}_{k}^{l}}{{q}_{{p}_{k}}} + {M}_{k} \times {h}_{k}^{l} ) )$$

$$- {d}_{k}^{l} log {x}_{k}^{l} \leq {z}_{k}^{l} , ∀ l , k ,$$

$${f}_{k}^{l} ( {X}_{k}^{l} ) \leq {q}_{k} + {y}_{k}^{l} , ∀ k : {d}_{k}^{l} > 0 , l ,$$

$${x}_{k}^{l} + {h}_{k}^{l} \geq {max}_{t} {d}_{k}^{l} ( t ) , ∀ l , k ,$$

$${y}_{k}^{l} \geq 0 , ∀ l , k .$$

Given Lagrange multipliers λ ∈ [symbol] ⁺ the Lagrangian relaxation problem decomposes into |K| sub-problems that can be solved independently from each other defined as follows:

Lagrangian sub-problem P¹ associated with flowgroup k ∈ K:

$${θ}_{k} = {min}_{x , z} {\sum }_{l} ( {z}_{k}^{l} + {λ}_{l} {x}_{k}^{l} ) + {\sum }_{l : {d}_{k}^{l} ( t ) > 0} ( \frac{{y}_{k}^{l}}{{q}_{{p}_{k}}} + {M}_{k} \times {h}_{k}^{l} )$$

$$- {d}_{k}^{l} log {x}_{k}^{l} \leq {z}_{k}^{l} , ∀ l ,$$

$${f}_{k}^{l} ( {X}_{k}^{l} ) \leq {q}_{k} + {y}_{k}^{l} , ∀ l : {d}_{k}^{l} > 0 ,$$

$${x}_{k}^{l} + {h}_{k}^{l} \geq {max}_{t} {d}_{k}^{l} ( t ) , ∀ l ,$$

$${y}_{k}^{l} \geq 0 , ∀ l .$$

Lagrangian sub-problem P² associated with flowgroup k ε K:

Solutions returned by P¹ do not guarantee the satisfaction of capacity constraints (1). Starting from a feasible solution x*, the following guarantees the feasibility of the solutions.

$${θ}_{k} = {min}_{x , z} {\sum }_{l} ( {z}_{k}^{l} + {λ}_{l} {x}_{k}^{l} ) + {\sum }_{l : {d}_{k}^{l} ( t ) > 0} ( \frac{{y}_{k}^{l}}{{q}_{{p}_{k}}} + {M}_{k} \times {h}_{k}^{l} )$$

$${x}_{l}^{k} - {x}_{l}^{k *} \leq \frac{{c}_{l} - L {V}_{l}}{( {max}_{t} {d}_{k}^{l} ( t ) ) \times \vert K \vert} \qquad ∀ l ,$$

$$- {d}_{k}^{l} log {x}_{k}^{l} \leq {z}_{k}^{l} , ∀ l ,$$

$${f}_{k}^{l} ( {X}_{k}^{l} ) \leq {q}_{k} + {y}_{k}^{l} , ∀ l : {d}_{k}^{l} > 0 ,$$

$${x}_{k}^{l} + {h}_{k}^{l} \geq {max}_{t} {d}_{k}^{l} ( t ) , ∀ l ,$$

$${y}_{k}^{l} \geq 0 , ∀ l .$$

The following distributed algorithm may permit to solve the Lagrangian relaxation and may converge to an optimal solution:

Algorithm 1: Sub-Gradient algorithm

| Output: Feasible solution x̅ | |
|---|---|
| 1 | Initialize λ(0) = 0, i = 0; |
| 2 | Solve problem P¹ and get solution x; |
| 3 | Solve problem P² and get solution x̅ ; |
| 4 | Enforce rate allocation using x̅ ; |
| 5 | Reception of θ^{k'} of every flowgroup k' (sent by each |
| source); | |
| 6 | Update of the Lagrangian multipliers : |
| | λₗⁱ⁺¹ = λₗⁱ + sⁱ(cₗ − LVₗ) |
| 7 | i = i + 1 and go to step 1; |
| $Choose {s}^{{}_{i}} = α \frac{B - ( - {\sum }_{l} {λ}_{l} {c}_{l} + {\sum }_{k} {θ}^{k} )}{{‖ c - LS ‖}^{2}} , where 0 \leq α \leq 2$ | |

The following provides an example of how the Rate & SLA Analysis module may operate to trigger help request messages 105.

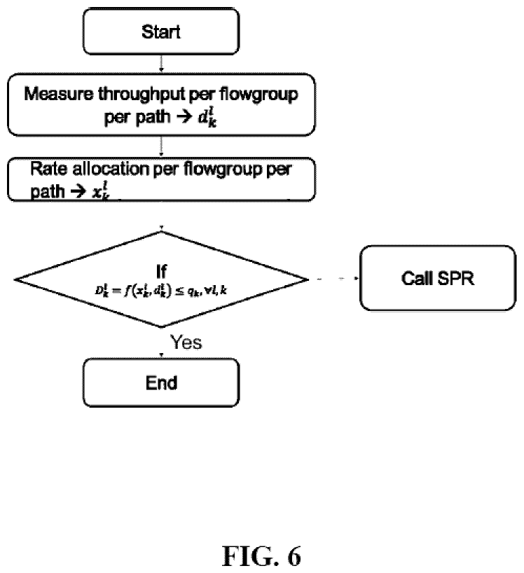

FIG. 6 shows steps that may be performed by an edge device 100 to trigger a help request 105.

The Rate & SLA Analysis module may periodically measure the throughput of each flow group and compare it with the rate allocation given by a plurality of queuing parameters 104. If the rate allocation is not enough to satisfy SLA requirements 101, a help request 105 can be triggered, for instance towards the SPR module of the network controller 201 in charge of load balancing.

As defined above xₖ^{l} is the rate used to tune WFQ weights and shaping. The allocation is performed to allocate all the available bandwidth, e.g. in a fair manner, and meet SLA requirements 101.

The estimation of SLA satisfaction may be based on an SLA prediction model, for instance, the end-to-end latency Dₖ^{l} for flow group k over the overlay links 1 can be a function f of xₖ^{l}, dₖ^{l} as shown in FIG. 6. This function can approximate the latency based on a closed-form expression from queuing theory or network calculus, or based on a data-driven approach with machine learning.

The embodiments of this disclosure combine some or all of the following benefits: The decisions may be determined locally. Thus, the scalability may be high. Edge devices collaborate through small data sizes of control information 102. Thus, the overhead may be low. Cooperation between smart queuing and routing is possible when needed.

The edge device 100 and/or the network controller 201 may comprise a processor. The processor may be configured to perform the method 300 with the edge device 100.

Generally, the processors may be configured to perform, conduct or initiate the various operations of the edge device 100 and/or the network controller 201 described herein. The processors may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The edge device 100 may further comprise memory circuitry, which stores one or more instruction(s) that can be executed by the processor, in particular under control of the software. For instance, the memory circuitry may comprise a non-transitory storage medium storing executable software code which, when executed by the processor, causes the various operations of the edge device 100 to be performed. In one embodiment, the edge device 100 may comprises one or more processors and a non-transitory memory connected to the one or more processors. The non-transitory memory may carry executable program code which, when executed by the one or more processors, causes the edge device 100 to perform, conduct or initiate the operations or methods described herein.

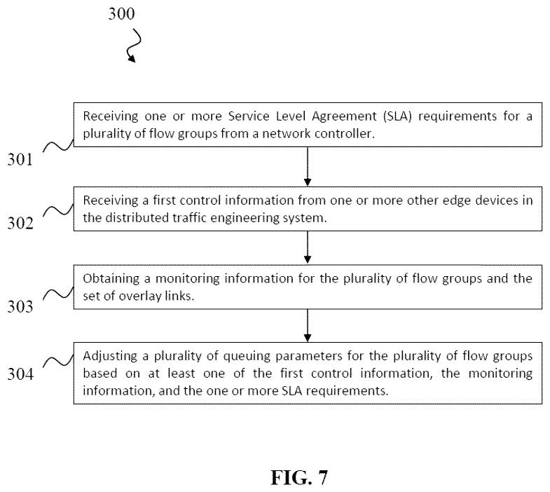

FIG. 7 shows a method 300 according to an embodiment of this disclosure. The method 300 may be performed by the edge device 100. The method 300 comprises a step 301 of receiving one or more SLA requirements for a plurality of flow groups from a network controller 201. Further, the method 300 comprises a step 302 of receiving a first control information 102 from one or more other edge devices 202 in the distributed traffic engineering system 200. Further, the method 300 comprises a step 303 of obtaining a monitoring information 103 for the plurality of flow groups and the set of overlay links. Further, the method 300 comprises a step 304 of adjusting a plurality of queuing parameters 104 for the plurality of flow groups based on at least one of the first control information 102, the monitoring information 103, and the one or more SLA requirements 101.

The disclosure has been described in conjunction with various embodiments as examples as well as implementations. However, other variations can be understood and effected by those persons skilled in the art and practicing the claimed matter, from the studies of the drawings, this disclosure and the claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An edge device for a distributed traffic engineering system with quality of service (QoS) control of a plurality of flow groups routed over a set of overlay links, wherein the edge device comprises:
a memory configured to store instructions; and
one or more processors coupled to the memory and configured to execute the instructions to cause the edge device to:
receive one or more service-level agreement (SLA) requirements for the plurality of flow groups from a network controller;
receive first control information from one or more other edge devices in the distributed traffic engineering system;
obtain monitoring information for the plurality of flow groups and the set of overlay links; and
adjust a plurality of queuing parameters for the plurality of flow groups based on at least one of the first control information, the monitoring information, or the one or more SLA requirements to obtain a plurality of adjusted queuing parameters.

2. The edge device of claim 1, wherein the instructions, when executed by the one or more processors, further cause the edge device to:
determine if a help request is required based on the monitoring information and the one or more SLA requirements; and
send, when the help request is required, the help request to the network controller.

3. The edge device of claim 2, wherein the instructions, when executed by the one or more processors, further cause the edge device to receive, after sending the help request, a routing policy from the network controller.

4. The edge device of claim 1, wherein the instructions, when executed by the one or more processors, further cause the edge device to:
determine second control information based on the plurality of adjusted queuing parameters or the monitoring information; and
provide the second control information to the one or more other edge devices.

5. The edge device of claim 2, wherein the instructions, when executed by the one or more processors, further cause the edge device to receive, from the network controller, one or more end points for the help request.

6. The edge device of claim 1, wherein the instructions, when executed by the one or more processors, further cause the edge device to further adjust the plurality of queuing parameters based on an SLA prediction model.

7. The edge device of claim 1, wherein the instructions, when executed by the one or more processors, further cause the edge device to forward traffic of each flow group of the plurality of flow groups over the set of overlay links.

8. The edge device of claim 2, wherein the instructions, when executed by the one or more processors, further cause the edge device to further determine if the help request is required based on an SLA prediction model or based on whether the one or more SLA requirements are met.

9. The edge device of claim 1, wherein the monitoring information comprises a measured throughput for each flow group of the plurality of flow groups or for each overlay link in the set of overlay links, and wherein the one or more processors execute the instructions to further cause the edge device to:
compare the measured throughput of each flow group with the one or more SLA requirements or with a plurality of rate allocations; and
send, when the measured throughput is not high enough to satisfy at least one of the one or more SLA requirements, a help request.

10. The edge device of claim 1, wherein the instructions, when executed by the one or more processors, further cause the edge device to further adjust the plurality of queuing parameters based on a class-based queuing (CBQ) architecture.

11. The edge device of claim 1, wherein the instructions, when executed by the one or more processors, further cause the edge device to determine a plurality of rate allocations based on a QoS optimization model.

12. The edge device of claim 11, wherein the QoS optimization model includes at least one of the following constraints:
capacities of each overlay link of the set of overlay links is satisfied,
an objective for fairness of rate allocations, or
SLA violations, rate allocations, or rate violations.

13. The edge device of claim 11, wherein the QoS optimization model includes at least one of the following inputs:
one or more flow groups in the plurality of flow groups,
one or more tunnels, wherein each of the one or more tunnels is defined by a first origin and a first destination,
the plurality of flow groups, wherein each flow group in the plurality of flow groups is defined by a class of traffic, a second origin, and a second destination,
a traffic demand of each flow group on each overlay link,
an SLA prediction model for each flow group on each overlay link,
an SLA requirement of each flow group, or
a penalty of demand violation of each flow group, or
wherein the QoS optimization model includes at least one of the following outputs:
a rate allocation of each flow group on each overlay link,
an SLA violation of each flow group on each overlay link,
a rate violation of each flow group on each overlay link, or
an intermediate variable of each flow group on each overlay link to optimize fairness according to a fairness objective.

14. A network controller for a distributed traffic engineering system with quality of service (QoS) control of a plurality of flow groups routed over a set of overlay links, wherein the network controller comprises:
memory configured to store instructions; and
one or more processors configured to execute the instructions to cause the network controller to:
send service level agreement (SLA) requirements for each flow group of the plurality of flow groups to two or more edge devices of the distributed traffic engineering system;
receive a help request from at least one edge device of the two or more edge devices in response to the SLA requirements; and
send a routing policy to the at least one edge device in response to the help request.

15. A method of operating an edge device for a distributed traffic engineering system with Quality of Service (QoS) control of a plurality of flow groups routed over a set of overlay links, wherein the method comprises:
receiving one or more Service Level Agreement (SLA) requirements for the plurality of flow groups from a network controller;
receiving first control information from one or more other edge devices in the distributed traffic engineering system;
obtaining monitoring information for the plurality of flow groups and the set of overlay links; and
adjusting a plurality of queuing parameters for the plurality of flow groups based on the first control information, the monitoring information, and the one or more SLA requirements to obtain a plurality of adjusted queuing parameters.

16. The method of claim 15, further comprising:
determining if a help request is required based on the monitoring information and the one or more SLA requirements; and
sending, if a help request is required, a help request to the network controller.

17. The method of claim 16, further comprising receiving, after sending the help request, a routing policy from the network controller.

18. The method of claim 15, further comprising:
determining second control information based on the plurality of adjusted queuing parameters or the monitoring information; and
sending the second control information to the one or more other edge devices.

19. The method of claim 15, further comprising further adjusting the plurality of queuing parameters based on an SLA prediction model.

20. The method of claim 16, further comprising further determining if the help request is required based on an SLA prediction model, or based on whether the one or more SLA requirements are met.
